(19) United States
(12) Patent Application Publication
(10) Pub. No.: US 2011/0082687 A1
(43) Pub. Date: Apr. 7, 2011

(54) METHOD AND SYSTEM FOR TAKING ACTIONS BASED ON ANALYSIS OF ENTERPRISE COMMUNICATION MESSAGES

(76) Inventor: Marcelo Pham, Miami, FL (US)

(21) Appl. No.: 12/836,947

(22) Filed: Jul. 15, 2010

Related U.S. Application Data
(60) Provisional application No. 61/278,100, filed on Oct. 5, 2009.
(60) Provisional application No. 61/279,974, filed on Oct. 29, 2009.
(60) Provisional application No. 61/395,641, filed on May 17, 2010.
(60) Provisional application No. 61/349,874, filed on May 30, 2010.

(51) Int. Cl. G06F 17/27; G10L 11/00

(52) U.S. Cl. 704/9; 704/E11.001

(57) ABSTRACT

A computer-based system receives and analyzes digital communication between at least one party in a business enterprise and another party using a natural language analyzer to extract meanings from the message. The system includes a database storing specific actions to be taken upon the detection of specified meanings in such communications. Certain actions may require the system to interrogate the enterprise computer system's database to locate the existence or nature of specified data. The directed actions take the form of communications within an enterprise to assist activities related to the analyzed digital communication.

### CROSS-REFERENCE TO RELATED APPLICATIONS

This application claims priority of U.S. Provisional Patent Applications 61/349,874 filed May 30, 2010; 61/395,641, filed May 17, 2010; 61/279,974, filed Oct. 29, 2009; 61/278,100, filed Oct. 5, 2009; which are all incorporated herein by reference.

### FIELD OF THE INVENTION

This invention relates to artificial intelligence software systems used in connection with enterprise computer systems to take actions which enhance the performance of the enterprise and more particularly to such a system which operates upon messages transmitted through the enterprise relating to its activities, using natural language analysis, to detect meanings from such messages and to initiate actions in support of the enterprise's business.

### BACKGROUND OF THE INVENTION

As businesses began to adopt software systems to effectuate specific aspects of their operations, such as finances, human resources, distribution functions, and the like, these separated systems began to become mutually dependent upon the information stored in the other systems and it became desirable to create integrated systems, commonly termed Enterprise Resource Planning (ERP) systems, which integrate the computer-based systems of a business. These systems are usually built on a central database and normally utilize a common computing platform to consolidate all business operations into a uniform and enterprise wide system environment.

Such ERP systems create the opportunity to provide associated systems which cooperate with the ERP system in achieving the goals of the business enterprise in an automated fashion to assist and enhance the performance of the enterprise workers in achieving the objectives of the enterprise.

A variety of systems have been proposed which operate toward these goals. For example, U.S. Pat. No. 7,734,670 relates to an email system that incorporates fields of metadata in email communications allowing recipients of the emails to add data to the blocks which becomes mapped to the fields of the metadata to populate databases of the enterprise.

### SUMMARY OF THE PRESENT INVENTION

The present invention is accordingly directed toward a software system associated with or incorporated as part of an enterprise computer system which analyzes messages involving enterprise activities, using natural language processing, to generate actions, typically messages transmitted in the communication channels of the enterprise, to enhance the efficiency and better achieve the goals of the enterprise. The enterprise may constitute a business formed as a legal entity, or any group of users having a shared purpose.

A preferred embodiment of the present invention, which will subsequently be disclosed in detail, generates these enterprise-enhancing actions based on the extraction of meanings from messages between at least one party in the enterprise and other party(s) who may or may not be within the enterprise, in connection with the normal business activities of the enterprise.

The enterprise messages from which the meanings are extracted may typically constitute enterprise versions of social network communications similar to Twitter or the like, emails, SMS messages, etc. The meanings are preferably extracted from these messages employing a natural language analyzer. In the preferred embodiment of the invention the analyzer extracts from the messages the mention of what are hereinafter termed “entities” which may constitute a person, object, or anything that relates to enterprise business operations. A typical entity may be a product or service that the enterprise sells, a customer that the enterprise sells to, a vendor, etc. The entities extracted are compared with the contents of an “internal entity” database which queries enterprise data master files to identify enterprise associated entities and which will typically be augmented over time either manually or by an automated procedure.

Entities stored in the entity database are categorized by type based upon the data master file they come from. Typical entity types may include items (products), product lines or categories, services, clients, vendors, contacts, prospects, projects, marketing campaigns, users, groups, departments or divisions, physical locations, and warehouses. When an entity is extracted from the analyzed communication and coincides with an entity stored in the entity database, the entity type as well as the particular entity are extracted. By way of example, for an entity that sells hardware, “nails” may be an entity and “product” the entity type.

The routine that analyzes the messages to extract meaning also analyzes certain aspects of the context of the message, such as verbs along with significant words that support the meaning of the message. These words can be nouns, personal pronouns, adverbs, adjectives, determiners, coordinating conjunctions, or modals. Through the verbs in the communication and the probabilistics of significant words and types of word combination along with the extracted entity and entity type, the routine queries a database which will be termed the “Context to Action” (“C>A”) database which may provide a predetermined meaning of the message. This database is preferably augmented based on the current activities of the enterprise.

If both the entity type and a meaning from the C>A database are found, the system will conduct a search of a directive database to locate a desired action for the system given the identified entity type and message context. The directives specify the output action of the system which may typically be sending a message formatted in a specified form to a specified recipient(s). A directive will often include a query directed to data stored in the enterprise database or database(s). By way of example, a conditional could be “search for old messages that mention the entity contained in the communication”. Alternatively, the query may ask if the inventory of a particular item is greater or less than an indicated amount.

If a directive contains a conditional involving a search of the enterprise data, a table or directory is consulted containing suggestions as to where the particular data may be contained within the enterprise database and the appropriate sections of the database are then searched for the required data for the conditional. If the data is found and the conditional satisfied, the system can then execute the directive located in the directive search based on the meanings extracted from the message by the natural language analyzer. The directives may take a variety of forms but often involve the transmission of a message, suggesting a course of conduct, directed to a particular employee, likely a participant in the original analyzed message but possibly other employees or groups of employees within the enterprise. The fact that a directive has been executed and the nature of the activity are entered into an executed directive log.

In this manner the system acts as a robotic assistant to the enterprise personnel performing the activities that enhance the efficiency of the enterprise operation.

### BRIEF DESCRIPTION OF THE DRAWINGS

Other objectives, advantages, and applications of the present invention will be made apparent from the following detailed description of a preferred embodiment of the invention. The description makes reference to the accompanying drawings in which:

FIG. 1 is an overall flowchart of a preferred embodiment of the present system illustrating both its method and structure;

FIG. 2 is a detailed flowchart of the Entity Analyzer routine which extracts the identity of entities referred to in the message as part of the natural language analysis;

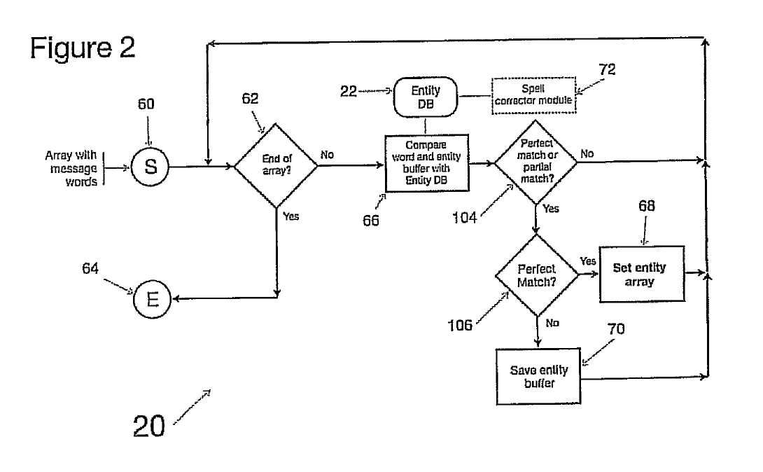

FIG. 3 is a detailed flowchart of the Contextual Analyzer routine which extracts meanings contained within the analyzed message based on natural language analysis routines; and

FIG. 4 is a detailed flowchart of the Conditional Analysis subsystem which receives directives based on the meanings extracted from the analyzed message and performs a search of the enterprise database(s) for those directives that include a conditional based on enterprise data.

### DETAILED DESCRIPTION OF A PREFERRED EMBODIMENT OF THE INVENTION

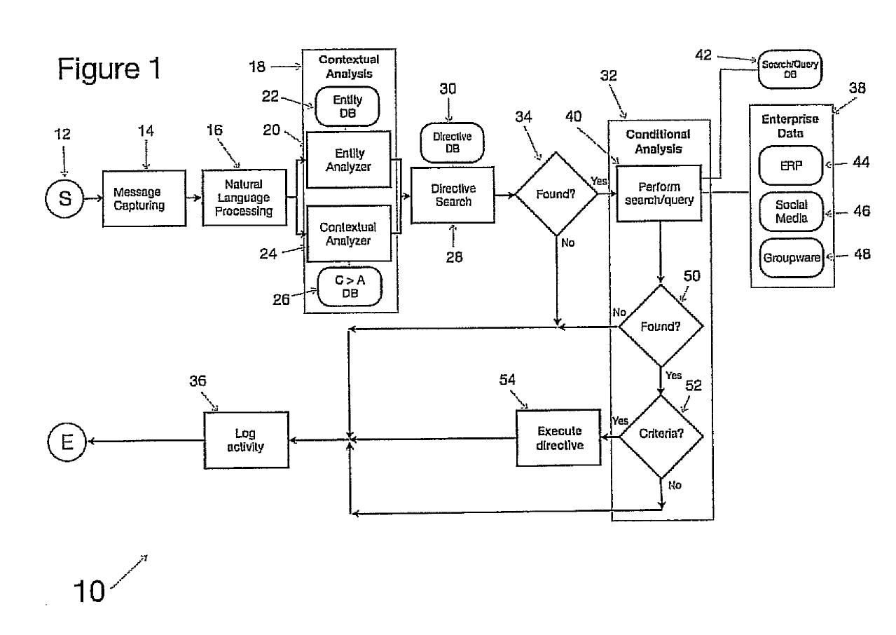

Referring to the drawings, and particularly to FIG. 1, an overall block diagram of a preferred embodiment of the system, generally indicated at 10, the input to the system at point 12, constitutes digital, natural language messages transmitted within the enterprise using any of a variety of communication systems such as email, Twitter, SMS, or the like. In other embodiments of the invention audio messages may be translated into digital text messages for analysis by the system.

By virtue of their being transmitted through the enterprise's communication system, at least one party to the message must be a worker within the enterprise. The other party may also be one or more workers in the enterprise and/or parties outside of the enterprise. The messages preferably relate to the business matters of the enterprise.

The messages are captured at routine 14 and are then passed to a natural language processing routine 16. This routine may incorporate a variety of techniques for operating upon the raw message to derive meanings useful to the enterprise. Typically this routine will format the message with a tokenizer to prepare the message for further processing and process the parts of speech in the message with a part-of-speech tagger which defines the grammatical nature of each word in the message. The natural language processing further may include a corpora used to do statistical analysis and hypothesis testing, checking occurrences, or validating linguistic rules in the message. The natural language processor 16 also includes a spelling corrector which uses the corpora for automatic spelling correction.

The routine 16 works in connection with a contextual analysis system 18. This routine includes an entity analyzer 20 which extracts entities, as previously defined, out of the message in any form that the entity is spelled with. This routine also includes a spell corrector, typically employing fuzzy logic, to extract entities expressed in different spellings.

The entities extracted are compared with the contents of an entity database 22 based upon queries to all enterprise data master files. The contents of the database 22 may be augmented over time either manually or by an automated procedure.

The natural language processing module 16 also prepares the message and puts all the words into an array which forms the input 60 of the entity analyzer. The array contains headers indicating the beginning and end of the array and a module 62 detects the end of the array and provides the output to an end detector 64 which terminates the analysis of the array. Each word in the array is provided to an analyzer 66 which compares the word with the contents of the entity database 22. The comparison 104 is for a perfect or partial match; for example, if the word being processed is “deception” and there is only one entity in the entity database 22 called “deception”, it is a perfect match 106 and the system will store that word in module 68 for further processing. If the word being processed is “the” and there are several entities in the entity database that start with that word (i.e., “The Foot Book”, “The Craft”, “The Lorax”), this is a partial match 104 and the module will store “the” in an entity buffer 70 to couple it with the next word or words in the message to find a perfect match. When the entity analyzer 20 compares each word against the entity database 22, it also checks for misspellings using a spell corrector module 72. For example, if the message contains the word “Suess” and the user meant “Seuss”, the module will not find a perfect match in the entity database, but using probabilistic letter combinations and phonetics the spell corrector will check for possible misspellings and will correct the error.

The entity analyzer 20 works in parallel with a contextual analyzer 24 which also receives the output of the natural language processing module 16. Based on the results of the natural language processor analysis of the significant words supporting the meaning of the message and the probabilistics of significant words and type of words combination, the contextual analyzer 24 compares the derived meaning of the message with the contents of a “C>A” database to determine if there is a matching record in that database corresponding to the context derived from the message. If there is, that context will be accompanied by a predetermined meaning of the message. For example, if the message says “I'm going to launch the X campaign next week”, the contextual analyzer will match up the words “going”, “launch” (verbs) and “campaign” (noun) and will find a matching record indicating that the context is “launching/releasing a product, category, or marketing campaign”.

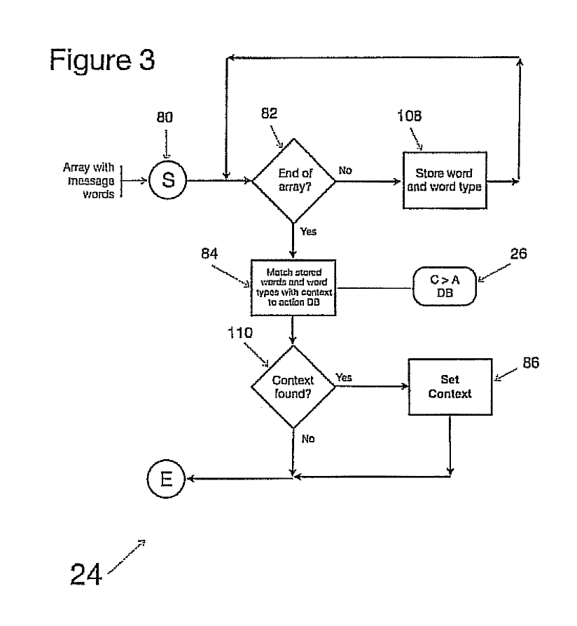

The more detailed operation of the contextual analyzer 24 is illustrated in FIG. 3. Again, the contextual analyzer receives the array of messages from the natural language processor module 16 at a start point 80. The end of the array is detected by a unit 82. Each word in the array is provided to an analyzer 108 which stores the words in groups by word type. For example, if the message is “I'm going to launch the Dr. Seuss campaign”, this module will store the words as follows: verbs: am, going, launch; determiners: the. In this case the words “Dr. Seuss” will be stored as an entity by the entity analyzer. The module 84 takes these words and word types and performs a search on the C>A database 26 which is essentially a dictionary of sentence forms indicating a predetermined context that expresses common business situations. In the example above the business situation being expressed is “launching a category or campaign”. This C>A database 26 can be augmented over time. If a context is found 110, the module will store the context for further processing in a unit 86.

The entity derived from the message as well as the entity type and the context derived from the contextual analyzer 24's interrogation of the C>A database 26, are provided to a directive search module 28. The module 28 works with an accompanying directive database 30. For the previous example the message “I'm going to launch the X campaign next week”, the directive search module will try to find a directive that has “product line” as the entity type and “launching/releasing a product, category, or marketing campaign” as the context. Directives located in the directive database 30 as a result of this analysis may or may not be provided with a conditional analysis routine 32. If no directive was located by the contextual analysis module 18, the routine 34 will provide an output directly to a log activity module 36 and the system will not take any action in aid of the analyzed message.

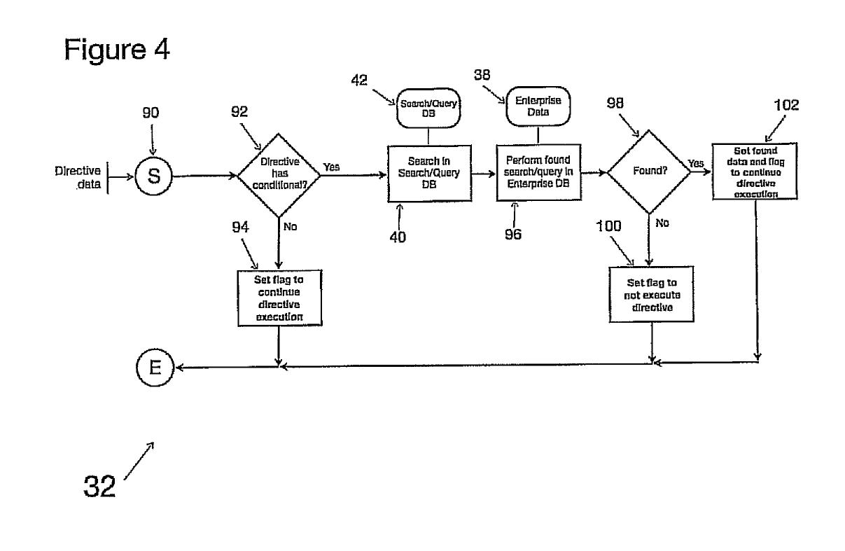

FIG. 4 details the conditional analysis module 32. The input to the module at 90 constitutes a directive found in the directive search. The directive is examined by module 92 to determine if it contains a conditional based on enterprise data. If it does not, a flag is set by unit 94 to continue the directive execution. If it does contain a conditional, the unit 40 analyzes the search/query database 42 to obtain a list of places to search for the required data in the enterprise data. The unit 96 then performs a search of the data in the enterprise database 38. The module 98 determines if the data has been found and if not it sets a flag in unit 100 indicating that the directive should not be executed. If the data was found, continue the directive execution not search.

For those messages in which a directive has been found, the routine 32 will perforin a query to the enterprise data 38 to determine the data needed to effectuate the directive. This search is performed by a module 40 which refers to a search/query database 42 containing a listing of files within the enterprise data 30 which may contain the data needed to perform the directive, The enterprise data 38 may be a single database or more than one database and will typically include an enterprise resource planning (ERP) subprogram 44, a social media program 46, a groupware program 48, as well as other databases associated with the enterprise processing system.

The output of the query for enterprise data needed to perform the directive is provided to an analysis block 50. If the required data has not been found, the unit 50 sends a signal to the log activity block and the directive takes no further action in aid of the meanings derived from the particular message.

If there is a criteria associated with the located directive, the routine 52 will analyze the extracted data to determine if the criteria is met. For example, the criteria may relate to present inventory quantities or customer receivable levels. They are usually mathematical comparisons dependent upon enterprise data. For example, if an extracted directive includes a conditional such as “check if the inventory term for the mentioned entity is less than X”, it may specify “X=4.5”. The routine 52 compares that conditional value to the data derived from the search of the enterprise database.

If the criteria is not met, the activity is then logged in unit 36 and no further action based upon the message is performed by the system. If the criteria is met, a signal is sent to the routine 54 which executes the directive located by the module 28. That directive is usually performed by sending one or more messages over the enterprise communication system, often to either the originator or the recipient of the message being analyzed, or both, or possibly to particular groups within the entity. For example, if employee A is having an issue with a specific subject, the action dictated by the directive can be to send a communication to employee A suggesting that he contact employee B, who is knowledgeable about that subject.

If the message meaning indicates that an employee is working on project B, the directive may require that a message be sent to that employee suggesting an employee C has already worked on that project. As another example, if the message states that the enterprise has received more orders from a particular customer, the search of the enterprise database may indicate that a customer has exceeded its credit limit and a communication may be sent to the employee who originated the message indicating that fact.

The message sent based upon an output of the execute directive module 54 is a configurable message that may be transmitted via Twitter or the like, emails, SMS messages, etc. The message is also configurable through field mapping. For example, if the message being analyzed indicates that a marketing campaign for a particular product line is about to be launched and the directive requires the system to determine if there is sufficient inventory to support the launch, the system will insert the name of the product line in the transmitted communication.

The specific manner of operation of the preferred embodiment of the invention can be better understood by reviewing the following examples of operation of the system dealing with specific messages:

### Example 1

### Profile Search Directive

For this example we will assume that there is one directive with the following specifications:

Name: “Connecting the dots”
Context to look for: “working on something related to . . . ”
Entity type to look for: “a category”
Conditional: “search old messages for someone who worked on the mentioned product line before”
Criteria: (no criteria)
Action to take: broadcast the following message “@{message_author} you may want to talk to @{found message_author} who expressed to have worked on {category} before”
i. John posts a message “I'm talking to a lead, trying to sell Spongebob Squarepants publishing rights”.
ii. The invention intercepts the message in module 14.
iii. The Natural Language Processing module 16 then processes the message by: a. preparing the message with a tokenizer (message is reformatted to “I am talking to a lead, trying to sell Spongebob Squarepants publishing rights”); b. tagging each word with a part of speech (POS) tagger (message is converted to “I (personal pronoun) am (verb) talking (verb) to a lead (noun), trying (verb) to sell (verb) Spongebob (proper noun) Squarepants (proper noun) publishing (noun) rights (noun)”.
iv. The entity analyzer 20 takes the message and compares it word by word against the contents of the entity database 22 to find and store “Spongebob Squarepants” in the entity array 68 along with its type (“category”).
v. The contextual analyzer 18 takes the message most significant words and word types to look for a context in the C>A database 26 to find and store the context “working on . . . ”.
vi. The directive search module 28 searches for a directive that has: a. “Working on . . . ” as the context; b. “Category” as the entity type; and finds the “Connecting the dots” directive.
vii. The directive has a conditional to search for old messages for someone who had worked on “Spongebob Squarepants” before, and it finds a 6 months old message from Jane: “Working on sales material for Spongebob Squarepants” in a search of the enterprise data 38.
viii. The directive has no criteria specified so it continues execution.
ix. The directive action to take is to broadcast the message “@{message_author} you may want to talk to @{found_message_author} who expressed to have worked on {category} before”. With field mapping the module replaces all the corresponding fields, with a resulting message “@John you may want to talk to @Jane who expressed to have worked on Spongebob Squarepants before”.
x. The message gets broadcast as a simulated user. John reads the invention's simulated user suggestion and contacts Jane. Jane may have spent hours or days in Spongebob Squarepants sales material which can be partially or fully reutilized by John for his new lead, saving John time and effort.

### Example 2

### Inventory Alert Directive

For this example we will assume that there is one directive with the following specifications:

Name: “Inventory alert for category campaigns”
Context to look for: “launching a marketing campaign for . . . ”
Entity type to look for: “a category”
Conditional: “inquiry on hand and minimum inventory for items belonging to the mentioned category”
Criteria: “if any item has less than the minimum +20% on hand”
Actions to take: broadcast the following message “@{message_author} warning, {category} has some items with low on hand, please check with Supplies”; and send an email to the Supplies division manager with the following message “@{message_author} plans to launch a campaign for {category}, which has some items with low on hand”
i. John posts a message “I'm going to launch the Dr. Seuss campaign tomorrow first thing”.
ii. The system intercepts the message at 12.
iii. The Natural Language Processing module 16 processes the message by: a. preparing the message with a tokenizer (message is reformatted to “I am going to launch the Dr. Seuss campaign tomorrow first thing”); b. tagging each word with a part of speech (POS) tagger (message is converted to “I (personal pronoun) am (verb) going (verb) to launch (verb) the Dr. (proper noun) Seuss (proper noun) campaign (noun) tomorrow (noun) first (cardinal number) thing (noun)”.
iv. The entity analyzer 20 takes the message and compares it word by word against the entity database 22 to find and store “Dr. Seuss” in the entity array 68 along with its type (“category”).
v. The contextual analyzer 24 takes the message most significant words and word types to look for a context in the context to action database 26 to find and store the context “launching a marketing campaign for . . . ”.
vi. The directive search 28 searches for a directive that has: a. “Launching a marketing campaign for . . . ” as the context; b. “Category” as the entity type; and finds the “Inventory alert for category campaigns” directive (described above).
vii. The directive has a conditional to inquiry on hand and minimum inventory for items belonging to the Dr. Seuss category:

Item: The Cat In the Hat—On Hand: 320—Minimum: 200

Item: The Foot Book—On Hand: 100—Minimum: 40

Item: The Lorax—On Hand: 200—Minimum: 190

viii. The directive has a criteria to detect if any item in the Dr. Seuss category has an on-hand level that is less than the minimum plus 20%:

Item: The Cat In the Hat—On Hand: 320<Minimum: 200+20%=240? false

Item: The Foot Book—On Hand: 100<Minimum: 40+20%=44? false

Item: The Lorax—On Hand: 200<Minimum: 190+20%=238? TRUE

The routine 102 will find that at least one item (The Lorax) matches the criteria so it will continue execution of the directive.
ix. One of the directive's action to take is to broadcast the message “@{message_author} warning, {category} has some items with low on hand, please check with Supplies”. With field mapping the module replaces all the corresponding fields, with the resulting message “@John warning, Dr. Seuss has some items with low on hand, please check with Supplies”.
x. The message gets broadcast as a simulated user. John reads the invention's simulated user suggestion and contacts Supplies before launching a campaign for Dr. Seuss, avoiding a campaign that would have probably run out of inventory and saving marketing dollars and efforts.
xi. The other directive's action is to send an email to the Supplies division manager the following message: “@{message_author} plans to launch a campaign for {category}, which has some items with low on hand”. With field mapping the module replaces all the corresponding fields, with a resulting message “@John plans to launch a campaign for Dr. Seuss, which has some items with low on hand”. The email is sent to notify the Supplies manager about the situation. If John decides to ignore the suggestion, the Supplies manager will be aware of the situation and will act accordingly.

While both of the above directives involve the transmission of enterprise messages, other actions such as sending messages to external systems or updating external databases or other storage systems could be accomplished by other directives.

Certain directives, called up upon the detection of meanings in messages which either commend or negatively criticize entities, may cause the generation of signals to a database which stores and sums these commendations and criticisms, to assist in the later evaluation of the entities. By way of example, the decision as to which of two vendors should be selected to supply a product to the entity may be influenced by the number of positive or negative mentions they receive in entity messages.

Having thus disclosed my invention, I claim:

1. A system associated with an enterprise computer system including a database, comprising:
a receiver for natural language messages between at least one party in an enterprise and at least one other party;
a natural language analyzer operative to extract meanings from said messages;
a first database storing specific actions of the system to be taken upon the detection of specified meanings in a message;
a module operative to search the first database using meanings detected in said messages and to output signals representative of desired specified actions; and
a directive execution module operative to generate signals to effectuate such desired specified actions.

2. The system of claim 1 further comprising:
a module operative to receive signals representative of said desired specific actions from said first database and to determine the existence of data required for execution of the desired specified action in the associated enterprise database, and wherein said directive module operates to generate signals to effectuate such desired specific actions only upon the determination of existence of said data in the enterprise database.

3. The system of claim 1 wherein the meanings extracted by said natural language analyzer from said messages comprise entities described by nouns in the messages referring to persons, objects, or things relating to the business of the enterprise.

4. The system of claim 3 wherein nouns extracted from the messages are compared with the contents of an internal entity database containing entities extracted from enterprise communication system databases.

5. The system of claim 1 wherein the meanings detected in said digital communication comprise verbs contained in the messages and the probabilistics of significant words and types of words combination.

6. The system of claim 1 wherein the module operative to search the first database using meanings detected in said messages employs a combination of detected entities, verbs, and probabilistics of significant words and types of word combination to search said first database.

7. The system of claim 1 wherein said desired specified actions comprise the generation of a communication to parties, within or external to the enterprise.

8. The system of claim 1 wherein said desired specific actions comprise updating enterprise or external storage system.

9. The system of claim 1 wherein said desired specified action comprises a communication to said at least one party in said enterprise containing instructions to contact other parties in the enterprise relative to the meaning of the message.

10. The system of claim 9 wherein the communication to said at least one party in the enterprise which generated the message comprises a suggestion for further action by such party.

11. The system of claim 9 wherein the communication to said party in the enterprise which generated the message relates to potential problems relating to the subject of said message.

12. The system of claim 1 further comprising a database storing a log of activities of said system including communications generated by said system.

13. The system of claim 1 wherein the specific actions of the system to be taken upon the detection of specified meanings in a message, stored in said first database, further comprise conditional statements based on the values of data required for execution of the desired specific action and the associated enterprise database.

14. A system for use in connection with a database of a business enterprise, comprising:
a communication network connectable to a plurality of workers in the enterprise for carrying natural language messages relating to the business of the enterprise;
a module for capturing said natural language messages;
a natural language analyzer for said messages for detecting word types and predetermined word type combinations contained in a message;
a database of predetermined possible meanings of messages;
a module for comparing word types and predetermined word type combinations detected in a message by the natural language analysis with the database of predetermined possible meanings of messages to generate a signal specifying a message meaning;
a database of action directives corresponding to message meanings;
a module for comparing said signal specifying a message meaning with said database of action directives to generate a signal representative of an action based on the message; and
a module for generating said action based on the message.

15. The system of claim 14 further comprising a database of entities associated with the enterprise comprising entity workers, entity projects, entity products, entity vendors, entity customers, and wherein said natural language analyzer extracts said entities from said message, and further comprising a module for comparing said entities extracted from the message with the contents of said database of entities associated with the enterprise to determine a correspondence and the entity associating with the correspondence is employed in said selection of an action based on the message.

16. The system of claim 14 wherein the action based on the message includes a condition related to the action and the system interrogates said database of the business enterprise to determine data related to the condition.
